(19) United States
(12) Patent Application Publication
(10) Pub. No.: US 2017/0253279 A1
(43) Pub. Date: Sep. 7, 2017

(54) OUTER PANEL FOR A MOTOR VEHICLE

(71) Applicant: FORD GLOBAL TECHNOLOGIES, LLC, Dearborn, MI (US)

(72) Inventors: Joshua R. Hemphill, White Lake, MI (US); Vincent Anthony Chimento, Plymouth, MI (US); Azazhusen V. Khatri, Dearborn, MI (US); Dragan B. Stojkovic, Taylor, MI (US); Steve William Gallagher, Bloomfield Hills, MI (US); Colleen Marie Hoffman, Canton, MI (US)

(21) Appl. No.: 15/057,612

(22) Filed: Mar. 1, 2016

(51) Int. Cl. B62D 29/00; B60J 5/04; B60R 13/04; B62D 25/06; B62D 27/02

(52) U.S. Cl. CPC B62D 29/005; B62D 25/06; B62D 27/026; B60R 13/04; B62D 29/008; B60J 5/048

(57) ABSTRACT

An outer panel is provided for a motor vehicle. That outer panel includes an outer panel body made from a non-ferromagnetic material and a ferromagnetic element connected to an inner surface of the outer panel body. The ferromagnetic element serves as a magnetic attachment point through the outer panel body for a magnetic accessory on the outer panel body of the motor vehicle.

### TECHNICAL FIELD

This document relates generally to the motor vehicle equipment field and, more particularly, to an outer panel for a motor vehicle wherein the outer panel body is made from aluminum and a ferromagnetic element is connected to an inner surface of the outer panel body to serve as a magnetic attachment point through the outer panel body for a magnetic accessory such as a magnetic sign or the like.

### BACKGROUND

A typical motor vehicle includes an expansive area of body panels in order to provide effective aerodynamics and an aesthetically pleasing appearance. In the past such body panels have generally been made from steel for strength and longevity. However, steel panels are relatively heavy and add substantially to the overall weight of the motor vehicle. This extra weight tends to reduce the fuel efficiency of the motor vehicle thereby increasing the operating cost.

This document relates to a new and improved outer panel for a motor vehicle where the outer panel body is made from a lightweight, nonferromagnetic material to allow for weight savings and higher motor vehicle fuel efficiencies. In addition, the outer panel body includes a ferromagnetic element connected to an inner surface thereof that serves as a magnetic attachment point through the outer panel body for a magnetic accessory such as a sign, antenna or a light made for magnetic attachment.

### SUMMARY

In accordance with the purposes and benefits described herein, an outer panel body is provided for a motor vehicle. That outer panel comprises an outer panel body made from a lightweight, nonferromagnetic material such as aluminum and a ferromagnetic element connected to an inner surface of the outer panel body. The ferromagnetic element serves as a magnetic attachment point through the outer panel body for a magnetic accessory such as one may wish to attach to and carry on the motor vehicle.

In one possible embodiment, the outer panel is a door panel. In another possible embodiment, the outer panel is a roof panel. The magnetic accessory may be a sign or the like.

The ferromagnetic element may be a steel plate contoured to nest flat against the outer panel body. The ferromagnetic element may be secured to the inner surface of the outer panel body by means of an adhesive or by means of fasteners such as, for example, rivets.

Where the outer panel is a roof panel, the ferromagnetic element is sandwiched between the outer panel and a headliner of the motor vehicle.

In some embodiments, the ferromagnetic element comprises multiple sheets of the ferromagnetic material. In some embodiments, the ferromagnetic element comprises a sheet of magnetized rubber material. In other embodiments, the ferromagnetic element comprises a sheet of magnetized plastic.

In the following description, there are shown and described several preferred embodiments of the outer panel. As it should be realized, the outer panel is capable of other, different embodiments and its several details are capable of modification in various, obvious aspects all without departing from the outer panel as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the outer panel and together with the description serve to explain certain principles thereof. In the drawing figures:

FIG. 1 is a side elevational view of an outer panel, in the form of a motor vehicle door, including an outer panel body made from a lighter-than-steel non-ferromagnetic material, such as aluminum, and a ferromagnetic element in the form of two sheets connected to an inner surface of the outer panel body.

FIG. 2 is a top plan view of an outer panel body for a motor vehicle wherein the outer panel takes the form of a motor vehicle roof made from a non-ferromagnetic material and a ferromagnetic element in the form of two sheets are connected to an inner surface of the outer panel body.

FIG. 3 is a schematic “edge-on” view clearly showing a magnetic sign attached to an outer panel body by means of magnetic attraction with a ferromagnetic element carried on the inner surface of the outer panel body.

FIG. 4 is an edge-on view of an outer panel body in the form of a roof panel showing how the ferromagnetic element connected to the inner surface of that outer panel body is sandwiched between the outer panel and a headliner of the motor vehicle.

Reference will now be made in detail to the present preferred embodiments of the outer panel for a motor vehicle, examples of which are illustrated in the accompanying drawing figures.

### DETAILED DESCRIPTION

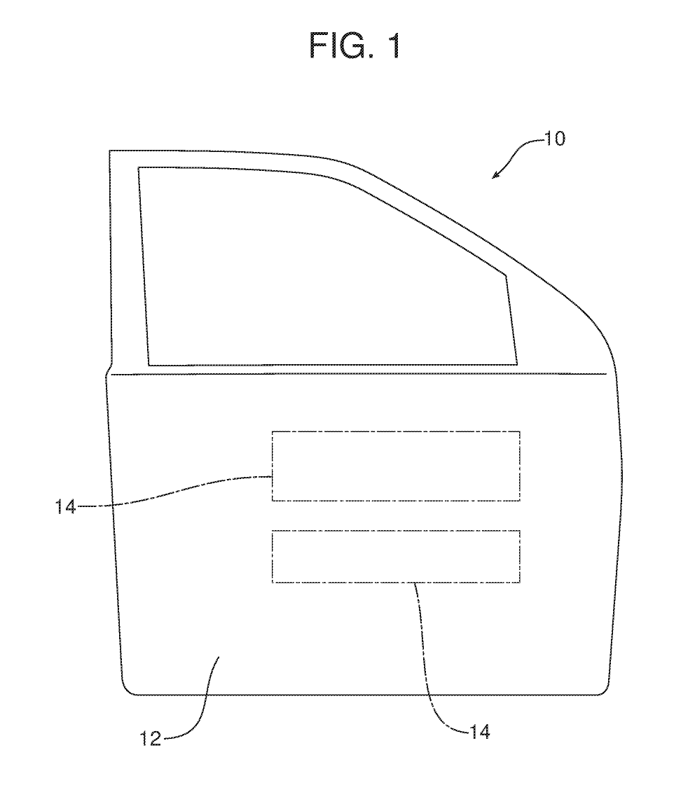

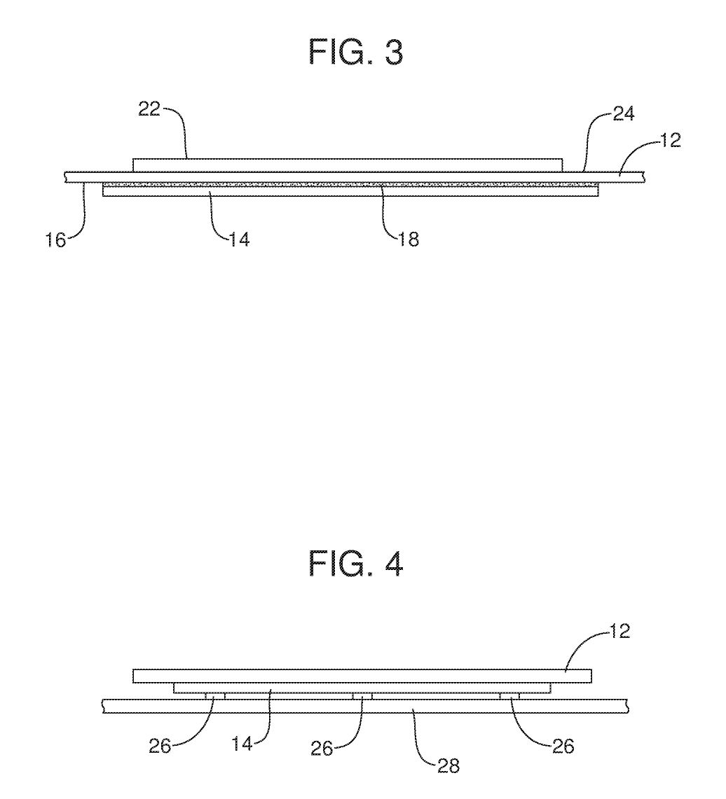

Reference is now made to FIG. 1 illustrating an outer panel 10 for a motor vehicle. In the embodiment illustrated in FIG. 1, the outer panel 10 comprises a door panel. As best illustrated in FIGS. 1 and 3, the outer panel 10 includes an outer panel body 12 made from a non-ferromagnetic material such as aluminum. For purposes of this document the term “aluminum” shall encompass aluminum and any of it alloys. In many embodiments, the nonferromagnetic material from which the outer panel body is made is lighter than steel so as to provide a motor vehicle of reduced weight. Such a motor vehicle will return greater fuel economy thereby significantly reducing operating costs for the benefit of the motor vehicle owner.

As further illustrated in FIGS. 1 and 3, the outer panel 10 also includes a ferromagnetic element 14 connected to an inner surface 16 of the outer panel body by an adhesive 18. As illustrated in FIG. 1, the ferromagnetic element 14 may comprise two sheets 20 of ferromagnetic material. Here it should be appreciated that the ferromagnetic element 14 can be made in many different configurations, sizes and lengths and the illustrated embodiment is simply a single example of what is possible. In any embodiment, the ferromagnetic element 14 may be contoured to nest flat against the inner surface 16 of the outer panel body 12. Here it should also be noted that the ferromagnetic element 14 may be made from any appropriate material including, for example, steel plate, a sheet of magnetized rubber material, a sheet of magnetized plastic or even combinations thereof. As illustrated in FIG. 3, a magnetic sign 22 is attached to the outer surface 24 of the outer panel body 12 by means of magnetic attraction to the ferromagnetic element 14 through the outer panel body 12.

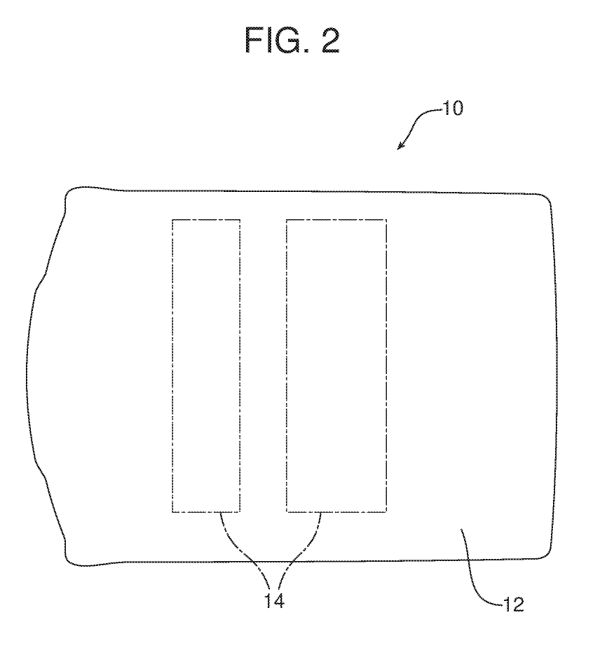

Reference is now made to FIGS. 2 and 4 illustrating an alternative embodiment wherein the outer panel 10 comprises a roof top of a motor vehicle. As illustrated in FIG. 4, in this embodiment, the ferromagnetic element 14 is secured to the inner surface 16 of the outer panel body 12 by means of a plurality of fasteners 26 which may take the form of, for example, rivets. As shown, the ferromagnetic element 14 is sandwiched between the outer panel 12 and a headliner 28 of the motor vehicle where it is concealed from view.

Similar to the first embodiment, the ferromagnetic element 14 in the second embodiment illustrated in FIGS. 2 and 4 may be made from substantially any appropriate ferromagnetic material including, but not necessarily limited to, steel plate, magnetized rubber material and magnetized plastic material. By positioning the ferromagnetic element against the inner surface of the outer panel body 12, the ferromagnetic element will function as a magnetic attachment point for any motor vehicle accessories designed or adapted to be mounted to a motor vehicle by means of magnetic force.

The foregoing has been presented for purposes of illustration and description. It is not intended to be exhaustive or to limit the embodiments to the precise form disclosed. Obvious modifications and variations are possible in light of the above teachings. For example, an embodiment wherein the outer panel 10 is a motor vehicle door is illustrated in FIGS. 1 and 3 and a second embodiment wherein the outer panel is a motor vehicle roof is illustrated in FIGS. 2 and 4. It should be appreciated that the outer panel 10 may assume other embodiments and panels of a motor vehicle including, but not necessarily limited to, a tailgate, a hood or a quarter panel. All such modifications and variations are within the scope of the appended claims when interpreted in accordance with the breadth to which they are fairly, legally and equitably entitled.

1. An outer panel for a motor vehicle, comprising:
an outer panel body made from a non-ferromagnetic material, wherein said outer panel is a door panel; and
a ferromagnetic element connected to an inner surface of said outer panel body, said ferromagnetic element serving as a magnetic attachment point through said outer panel body for a magnetic accessory.

2. (canceled)

3. The outer panel of claim 1, wherein said outer panel is a roof panel.

4. The outer panel of claim 1, wherein said magnetic accessory is a sign.

5. The outer panel of claim 1, wherein said ferromagnetic element is a steel plate contoured to nest flat against said outer panel body.

6. The outer panel of claim 1, wherein said ferromagnetic element is secured to said inner surface of said outer panel body by means of adhesive.

7. The outer panel of claim 1, wherein said ferromagnetic element is secured to said inner surface of said outer panel body by means of fasteners.

8. The outer panel of claim 7, wherein said fasteners are rivets.

9. The outer panel of claim 1, wherein said outer panel is a roof panel and said ferromagnetic element is sandwiched between said outer panel and a headliner of said motor vehicle.

10. The outer panel of claim 1, wherein said ferromagnetic element comprises multiple sheets of ferromagnetic material.

11. The outer panel of claim 1, wherein said ferromagnetic element comprises a sheet of magnetized rubber material.

12. The outer panel of claim 1, wherein said ferromagnetic element comprises a sheet of magnetized plastic.

13. The outer panel of claim 1, wherein said nonferromagnetic material is aluminum.

14. (canceled)

15. (canceled)
